(19) United States
(12) Patent Application Publication
(10) Pub. No.: US 2020/0044347 A1
(43) Pub. Date: Feb. 6, 2020

(54) LOOP ANTENNA SYSTEM AND MOBILE TERMINAL

(71) Applicant: AAC Technologies Pte. Ltd., Singapore city (SG)

(72) Inventors: Mingjun Hang, Shenzhen (CN); Yufei Zhu, Shenzhen (CN); Dawei Shi, Shenzhen (CN); Kai Dong, Shenzhen (CN)

(21) Appl. No.: 16/524,044

(22) Filed: Jul. 27, 2019

(30) Foreign Application Priority Data
Aug. 3, 2018 (CN) 201821251442.3

(51) Int. Cl. H01Q 7/00; H01Q 1/24; H01Q 5/328; H04B 7/0413; H01Q 5/50

(52) U.S. Cl. CPC H01Q 7/00; H01Q 1/241; H01Q 5/50; H04B 7/0413; H01Q 5/328

(57) ABSTRACT

A loop antenna system, comprising a plastic back shell and a main board accommodated in the plastic back shell, wherein the loop antenna system comprises a loop antenna disposed on a surface of the plastic back shell, the main board is disposed with a ground switch and a feed point which are connected to the loop antenna. The loop antenna at least has two operation states by adjusting the ground switch, wherein one state is that the loop antenna operates at a GSM900 TX frequency band, and the other state is that the loop antenna operates at a GSM900 RX frequency band.

### TECHNICAL FIELD

The present disclosure relates to the field of antenna technology, especially a loop antenna system and a mobile terminal.

### BACKGROUND

With continuous development of communication technology, requirements of a mobile terminal are more and more diversified, and thus requirements of an antenna in the mobile terminal are increasingly demanding.

At present, a screen-to-body ratio is increasingly higher in the mobile terminal like a mobile phone, rendering that a clearance region within the mobile terminal is getting smaller, which results in even worse environment for an antenna. Currently, multi-band addition is a main problem in antenna debugging. A small clearance region and narrow frequency band width of an antenna cannot meet performance criteria requirements. A diversity region of a notch screen is poor in environment and cannot be switched by DPDT.

Therefore, it is necessary to provide a new loop antenna system to solve the above-described problem.

### BRIEF DESCRIPTION OF THE DRAWINGS

In order to describe technical solutions in the embodiments of the present disclosure more clearly, accompany drawings used to describe the embodiments are briefly illustrated below. It is evident that the drawings in the following description are only some embodiments of the present disclosure. For skilled persons in the art, in a case where no inventive effort is made, other drawings may be obtained according to these drawings.

FIG. 1 is a perspective structural view of a loop antenna system in the present disclosure;

FIG. 2 is a exploded perspective view of the loop antenna system in the present disclosure;

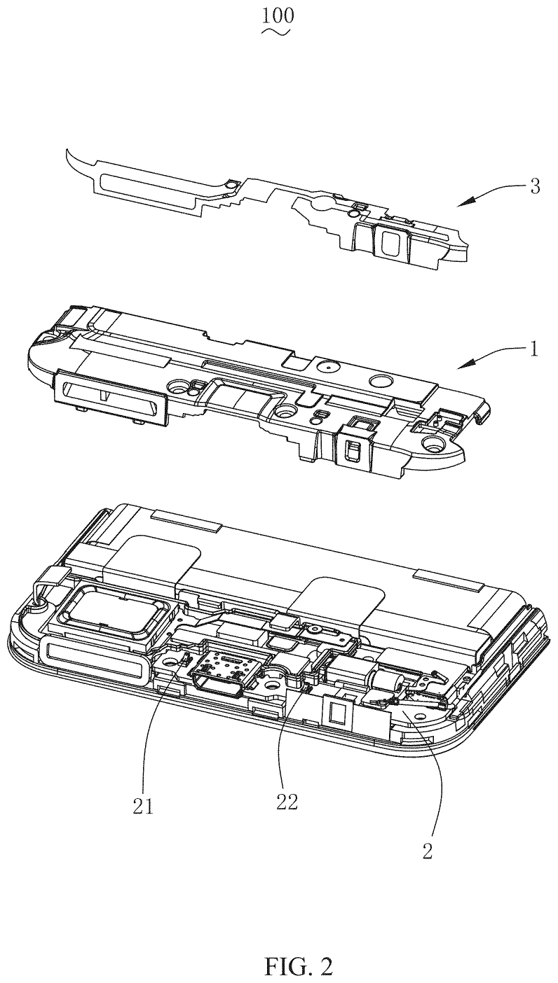

FIG. 3 is a schematic view of a main board of the loop antenna system in the present disclosure;

FIG. 4 is a diagram showing return loss of the loop antenna system in the present disclosure when GSM900 TX and GSM900 RX share a same path;

FIG. 5 is a diagram showing return loss of the loop antenna system upon a GSM900 TX path in the present disclosure;

FIG. 6 is a diagram showing return loss of the loop antenna system upon a GSM900 RX path in the present disclosure;

FIG. 7 is a diagram showing a comparison between efficiency tests of the loop antenna system in the present disclosure before and after GSM900 TX and GSM900 RX are assigned different paths.

### DETAILED DESCRIPTION

The technical solutions in embodiments of the present disclosure will be clearly and completely described with reference to the accompany drawings of the present disclosure. It is evident that the embodiments described are only some rather than all embodiments of the present disclosure. Based on the embodiments of the present disclosure, all other embodiments obtained by skilled persons in the art without making any inventive effort fall into the disclosure of protection by the present disclosure.

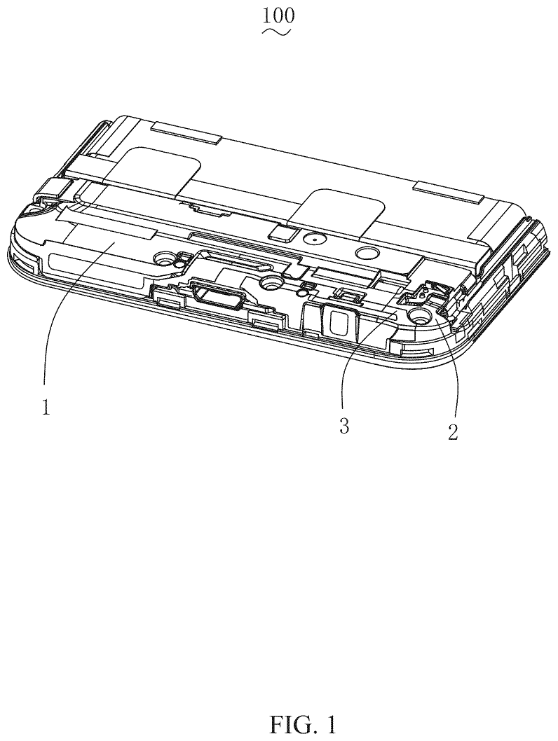

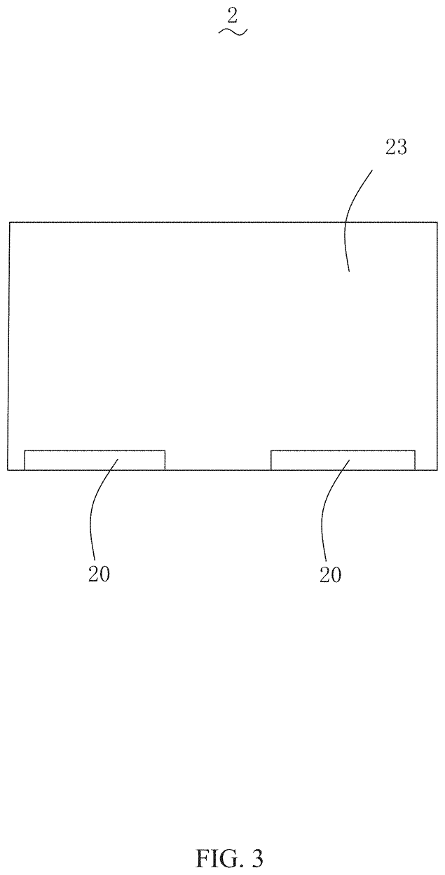

With reference to FIGS. 1 and 3, an embodiment of the present disclosure provides a loop antenna system 100, including a plastic back shell 1 and a main board 2 accommodated in the plastic back shell 1. A clearance region 20 is disposed at one end of the main board 2. In a specific embodiment of the present disclosure, the clearance region 20 consists of two clearance regions spaced from each other. One clearance region 20 has a length of 27.61 mm and a width of 2.73 mm, while the other clearance region 20 has a length of 29.38 mm and a height of 2.73 mm. The width of the clearance region 20 refers to a distance between a system ground 23 on the main board 2 and an edge of the main board 2.

The loop antenna system 100 includes a loop antenna 3 formed on a surface of the plastic back shell 1 through the Laser Direct Structuring (LDS) process, the loop antenna 3 is corresponding to the clearance region. By using the LDS process, the existing problem of a color difference at a gap in a conventional metal ring solution may be effectively avoided. An operation frequency band of the loop antenna 3 is a GSM900 frequency band.

The main board 2 is disposed with a ground switch 21 and a feed point 22 which are connected to the loop antenna 3. Naturally, the main board 2 is further installed with other electronic elements such as a loudspeaker, a microphone, a USB interface, a motor and so on, which are not marked on the drawings.

The loop antenna 3 is connected to the ground switch 21 and the feed point 22. By adjusting the ground switch 21, it is realized that low frequency bands GSM900 TX and GSM900 RX are grounded through two paths, so that both GSM900TX and GSM900RX can meet performance requirements. That is, by adjusting the ground switch 21, the loop antenna 3 at least has two operation states, in one of which the loop antenna operates at the GSM900 TX frequency band, while in the other the loop antenna operates at the GSM900 RX frequency band.

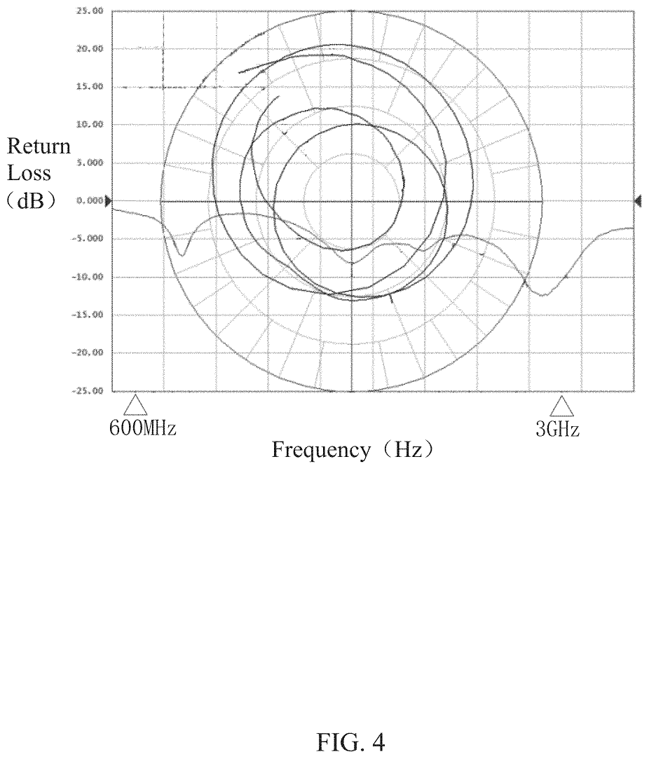

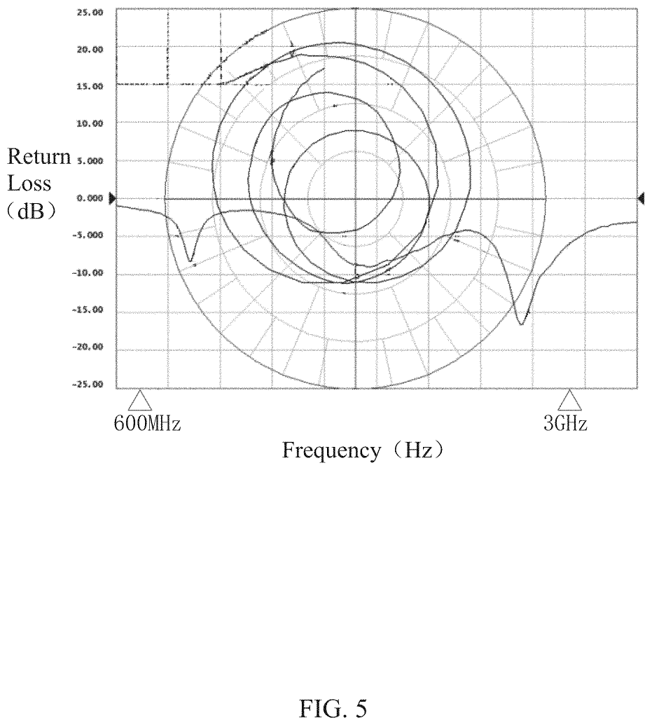

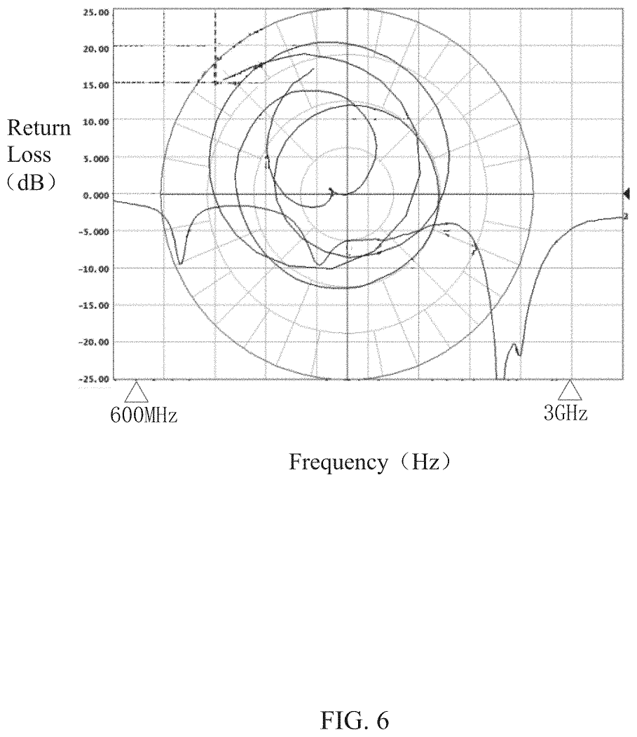

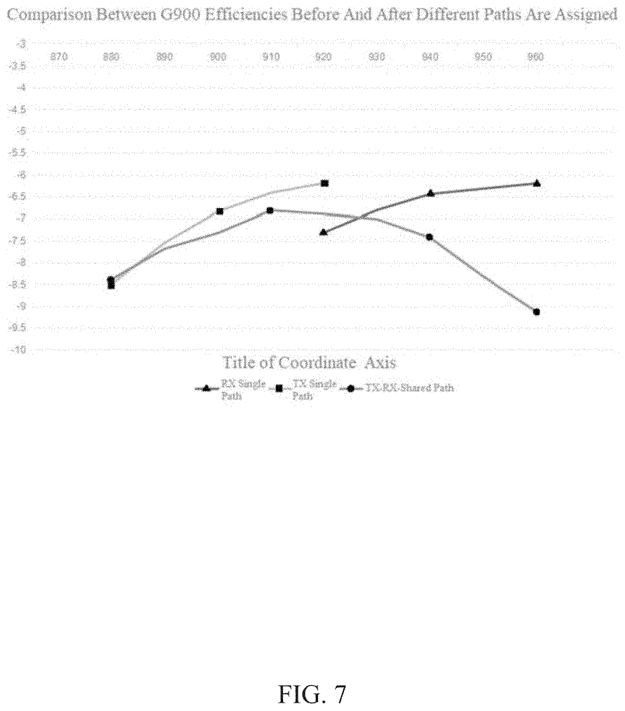

As shown in FIG. 4, when GSM900TX and GSM900RX share one path, rather than two paths, the band width is narrow and it is difficult to meet human head-hand test requirements. When GSM900TX and GSM900RX are grounded through two paths, their respective return losses are shown as FIGS. 5-6. It is seen that when GSM900TX and GSM900RX are grounded through two paths, their respective band widths are sufficient. With further reference to FIG. 7, a TX-and-RX-shared path curve represents a test efficiency of GSM900 TX and GSM900RX in the path, and the performance is poor. An RX single-path curve and a TX single-path curve respectively represent test efficiencies of GSM900 TX and GSM900RX when two paths are used. Accordingly, compared with a TX-and-RX-shared path, a better performance is obtained by low frequencies GSM900 TX and GSM900RX through different paths.

The present disclosure further provides a mobile terminal, including a notch screen, i.e., a screen obtained by an irregularly-cut process, and including the above loop antenna system 100.

Compared with a related art, the loop antenna system provided in the present disclosure has the following advantageous effect: by providing a ground switch, the loop antenna at least includes two operation states, in one of which the loop antenna operates at the GSM900 TX frequency band, while in the other the loop antenna operates at the GSM900 RX frequency band, thereby realizing performance requirements at the low frequency bands of GSM900 TX and GSM900 RX.

The above-described are only embodiments of the present disclosure. It shall be noted that those skilled in the related art may make improvements without departing from the concept of the present disclosure. All these improvements fall into the protection scope of the present disclosure.

What is claimed is:

1. A loop antenna system, comprising a plastic back shell and a main board accommodated in the plastic back shell;
wherein the loop antenna system comprises a loop antenna disposed on a surface of the plastic back shell;
the main board is disposed with a ground switch and a feed point which are connected to the loop antenna; and
the loop antenna at least has two operation states by adjusting the ground switch, wherein one state is that the loop antenna operates at a GSM900 TX frequency band, and the other state is that the loop antenna operates at a GSM900 RX frequency band.

2. The loop antenna system according to claim 1, wherein a clearance region is disposed at an end corresponding to the loop antenna, of the main board, and the clearance region has a width of 2.73 mm.

3. The loop antenna system according to claim 1, wherein the loop antenna is formed at the plastic back shell through a LDS process.

4. A mobile terminal, wherein the mobile terminal comprises a loop antenna system described in claim 1.

5. The mobile terminal according to claim 4, wherein a clearance region is disposed at an end corresponding to the loop antenna, of the main board, and the clearance region has a width of 2.73 mm.

6. The mobile terminal according to claim 4, wherein the loop antenna is formed at the plastic back shell through a LDS process.
